(19) United States
(12) Patent Application Publication
(10) Pub. No.: US 2003/0163347 A1
(43) Pub. Date: Aug. 28, 2003

(54) Program for providing affordable housing

(76) Inventors: R. Frank Shaw, Larkspur, CO (US); William B. Frizell, Larkspur, CO (US)

Correspondence Address: GLENN L WEBB, P.O. BOX 951, CONIFER, CO, 80433

(21) Appl. No.: 10/376,382

(22) Filed: Feb. 26, 2003

Related U.S. Application Data
(60) Provisional application No. 60/319,125, filed on Feb. 26, 2002.

(51) Int. Cl. G06F 17/60

(52) U.S. Cl. 705/1; 705/35

(57) ABSTRACT

A program for providing affordable housing. The program includes setting up an entity to initially own/build housing. The housing is sold to qualified buyers at a price below market value. The entity receives a preset payment at a later time to compensate for the reduced price. The buyers receive a greater portion of the equity than in previous programs.

### RELATED APPLICATIONS

This application relates to the subject matter of provisional patent application 60/319,125 filed on Feb. 26, 2002.

### FIELD OF THE INVENTION

This application relates to the field of affordable housing programs.

### BACKGROUND OF THE INVENTION

The issue of obtaining home ownership is one of critical importance. This is particularly critical in areas that are experiencing population growth. The increase in population growth drives up demand for housing, and often, the less affluent are unable to find affordable housing to purchase. This demand also affects rent payments thus further limiting the ability of the less affluent to save sufficient amounts for a down payment for housing as well.

There have been previous attempts at solving this problem. In some locales, developers may be required to “set aside” a certain number of units as “affordable housing”. These regulations tend to be opposed as limiting the market, that even these units may not be affordable, and does not help those unable to provide a down payment.

Another approach is disclosed in U.S. Pat. No. 5,689,649, issued to Altman et al. That disclosed approach utilizes an accelerated payment schedule for the mortgage to reduce the time for repayment of the principal. It does not assist purchasers with the down payment or provide incentives for developers or other interested parties to provide initial equity for purchasers.

In the late 1980s, programs existed wherein an investor would provide the down-payment for an owner-occupant. The investor would then collect half the profits plus the down payment when the property was sold. These programs limited the amount of equity that the actual homeowner gained in the profit to less than one-half of the actual equity, plus the investor typically would not realize their investment until such time the property was resold, thus creating pressure on the owner to sell the property. Also, there was great difficult in obtaining financing of these programs as well as the potential for fraud.

There presently is a critical need for a solution for providing affordable housing.

### SUMMARY OF THE INVENTION

The present invention solves these and other problems by providing a unique system that reimburses the entity initially providing affordable housing while allowing buyers the opportunity to gain equity in their purchased house.

The present invention provides solutions that allow qualified buyers to obtain housing at an affordable price. The entities providing the affordable housing are guaranteed an amount to compensate them for developing and selling the housing at below market rates.

The present invention provides solutions that allow the development of affordable housing without the need for public subsidies, or if subsidies are provided, then the repayment of those subsidies.

The present invention provides solutions that allow qualified buyers to purchase housing at below market rates and to achieve equity in the housing to improve their overall worth.

The present invention provides these solutions that allow qualified buyers to achieve housing and equity at an affordable price while guaranteeing that the buyers do not gain a windfall at the expense of the entity providing the housing.

In a preferred embodiment of the present invention, an entity is formed to develop and manage affordable housing. The entity retains ownership of the housing until such time that the housing is sold to qualified buyers. Then the entity receives a recordable agreement, such as a contract, lien, second mortgage or other agreement that guarantees the entity payment of a preset amount once equity in the housing has achieved at least that equity, through appreciation or payment of the mortgage. The purchaser then retains the value of the remaining equity in the housing once the preset amount is paid to the entity.

In another preferred embodiment of the present invention, the price of the house is controlled for subsequent purchasers. This ensures that the housing remains in a pool of affordable housing. The controlled price is adjusted to allow the purchasers to resell at a price that allows them to achieve a minimum level of equity.

These and other features of the present invention will be evident from the ensuing detailed description of preferred embodiments and from the drawings.

### BRIEF DESCRIPTION OF THE DRAWINGS

FIG. 1 is a schematic diagram of the process of a preferred embodiment of the present invention.

FIG. 2 is a schematic diagram of the process of a preferred embodiment of the present invention.

### DETAILED DESCRIPTION OF PREFERRED EMBODIMENTS

The present invention provides incentive processes for providing affordable housing. It is to be expressly understood that the descriptive embodiments set forth herein are intended for explanatory purposes and is not intended to unduly limit the scope of the claimed inventions. Other embodiments and applications not described herein are considered to be within the scope of the claimed inventions.

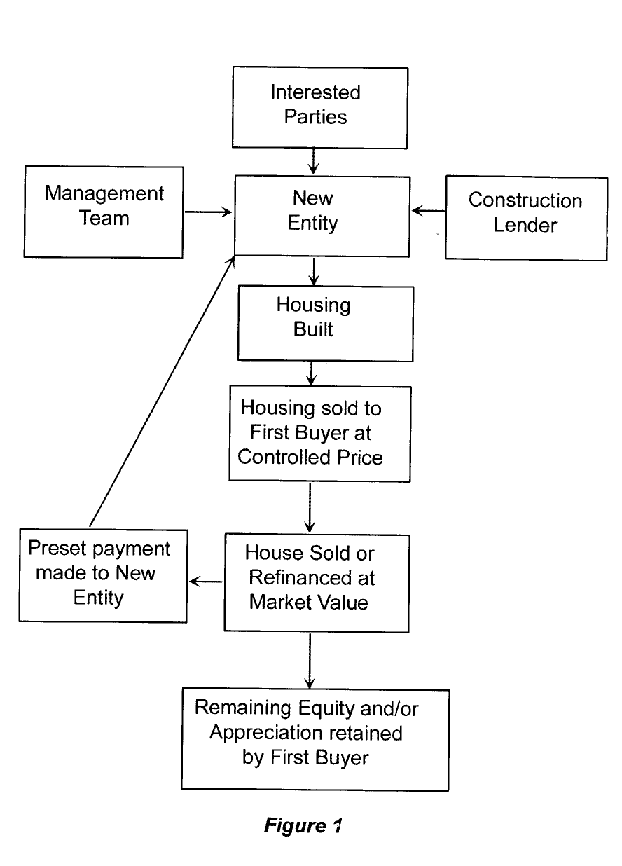

The present invention provides the ability for the home owner to gain equity in affordable housing as the equity in the housing grows, either through appreciation or payment of the principle of the mortgage while at the same time ensuring that the entity providing the affordable housing, such as a developer, the owner of the land, a bank or other party, regains the loss they incurred in providing the housing at a price less than the original market value of the housing. A preferred embodiment of this process of the present invention is shown in the flowchart illustrated in FIG. 1. Initially a new entity is created, preferably with the inclusion of the developer and/or owner of the property. It is to be expressly understood that the new entity may be made up of any combination of interested parties, and may even be solely a housing authority, a builder, a developer, a foundation or any other entity. The new entity is can be a non-profit, for-profit, governmental entity or any other entity or combination of entities

The interested party provides the land and holds all the cost and liability for the land. The new entity obtains the construction loans and holds title to the land and houses until they are sold to home owners. The housing is built and managed by either the new entity or by different members of the new entity. Prospective owners are qualified as to the eligibility for the process. This eligibility may restrict the program to certain income levels (minimum and maximum) and/or ability to make payments. The first owner then is sold the housing at an “affordable” price. This affordable price will be less than the original market value of the housing. The new entity receives a recordable agreement that requires at an appropriate time, either fixed or when the appraised value of the house allows it, the house is either sold or refinanced at market value. The new entity then receives an amount that was preset at the time of the initial purchase of the house. Typically, this preset amount would be the difference between the original market value of the housing and the original sale price of the housing, plus any interest that may be agreed upon by the parties, if any. The first owner of the house would then retain the appreciation in the value of the housing, that is, the difference between the original sale price and the current market value of the housing, less the amount paid to the non-profit entity. The new entity may use their proceeds to the next development of affordable housing.

The agreement between the new entity and home owner may be a security interest in the property, a second mortgage, a lien, or simply a contract between the parties. Preferably, in the preferred embodiment, the portion of the sale price received by the new entity once the property is resold or refinanced at market value is fixed at the time of the first purchase. The new entity will receive the difference between the first sale price of the property and the market value of the property at the time of the first sale and possibly a fair interest rate. Unlike earlier “shared equity” agreements, the equity is not equally split between the parties. The first buyer will then receive the appreciation in the value of the housing.

This process differs substantially from the prior shared equity real estate investments of the past. In those shared equity real estate investments, for-profit investors would receive not only the down payment loaned in the initial transactions but would also receive half of the profits of the sale as well. This greatly reduces the equity retained by the initial home buyer, thus reducing their incentive to maintain the property, make payments on the house, and otherwise provide incentives for the home buyer. Also, in order to maximize their investment, the investor would usually only desire to invest in expensive neighborhoods, thus pricing out the buyers seeking affordable housing.

In the present process, the new entity is providing a public service while protecting the builders/developers from economic loss. The initial funding may be provided by a public entity, or a private consortium of interested parties, such as builders, developers, lenders and others or even required as part of the zoning/permitting process. Once the first round of housing has been resold or refinanced, then further housing projects may be financed in another round of building. Also, bonds or other public/private debt may be sold to provide the housing financing and repaid once the housing has been sold or refinanced.

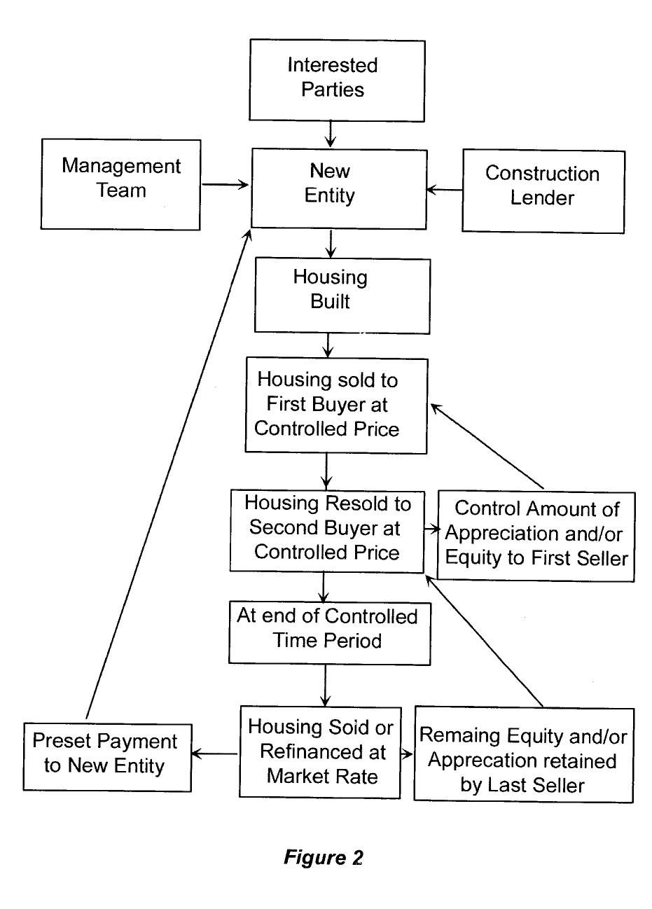

In another preferred embodiment shown in FIG. 2, a similar process is utilized except that the house is resold only at a controlled price below market value. This ensures that the affordable housing is retained in the affordable housing pool. The first (and subsequent owners) are allowed to retain the equity realized through appreciation and through reduction of the principle. Other buyers are benefited by the ability to purchase housing at an affordable price.

It is to be expressly understood that other embodiments of this model may be used. For example, a for-profit entity may be created to manage the process. Also, a public entity may also be used to manage the process. The new entity could be a non-profit, limited liability company corporation, partnership or any other type of entity or combination of entities. Other embodiments are also considered to be within the scope of the present invention.

What is claimed is:

1. A process for providing affordable housing, said process comprising the steps of:
creating an entity to manage the process;
said entity providing at least one unit of housing;
selling said at least one unit of housing to qualified buyers at a controlled price;
providing an agreement between said qualified buyers and said entity that defines a preset payment to be paid to said entity upon reselling or refinancing of said at least one unit of housing by said qualified buyers; and
said qualified buyers paying said entity a preset amount once said at least one unit of housing is resold or refinanced.

2. The process of claim 1 wherein said process further includes the step of:
said qualified buyers retaining the value of the remaining equity of said at least one unit of housing after said preset amount is paid to said entity.

3. The process of claim 1 wherein said process includes the step of: said entity includes interested parties;
at least one of said interested parties having ownership of land on which said at least one unit of housing is constructed; and
said at least one of said interested parties retaining ownership of said land until said at least one unit of housing is sold.

4. The process of claim 1 wherein said process includes:
said entity obtaining any construction loans for the building of said at least one unit of housing;
said entity retaining title to said at least one unit of housing until such time as said at least one unit of housing is sold to said qualified buyers.

5. The process of claim 1 wherein said process includes:
recording said agreement between said entity and said qualified buyers to provide notice of said preset amount owed to said entity by said qualified buyers.

6. The process of claim 1 wherein said process further comprises:
controlling the price at which said at least one unit of housing may be sold for a preset period of time so that said at least one unit of housing remains affordable to subsequent buyers.

7. The process of claim 6 wherein said process further includes:
said controlled price includes a fixed rate of appreciation to allow subsequent purchasers of said at least one unit of housing an opportunity to gain equity in said at least one unit of housing.

8. The process of claim 1 wherein said process includes:
said entity formed as a non-profit entity.

9. The process of claim 1 wherein said process includes:
said entity formed as a for-profit entity.

10. The process of claim 1 wherein said process includes:
said entity including a combination of interested parties.
